(19) United States
(12) Patent Application Publication
(10) Pub. No.: US 2002/0057707 A1
(43) Pub. Date: May 16, 2002

(54) Method and apparatus (router) for selecting connection route on communication line network and recording medium for storing a program for selecting the connection route

(76) Inventors: Tadashi Yamamoto, Tokyo (JP); Youji Mukuda, Hatano-shi (JP)

Correspondence Address: KANESAKA AND TAKEUCHI, Suite 2, 1423 Powhatan Street, Alexandria, VA, 22314, US

(21) Appl. No.: 09/792,066

(22) Filed: Feb. 26, 2001

(30) Foreign Application Priority Data
Nov. 15, 2000 (JP) 2000-348387

(51) Int. Cl. H04L 12/28

(52) U.S. Cl. 370/422; 370/252

(57) ABSTRACT

The processor 10 of the router 1a connects each of a plurality of adjacent routers 1b, . . . , 1n at a predetermined time specified by the timer 14 so as to collect line information of the communication line network A and execute an optimization processing for selecting an optimal communication route. This optimization enables data to be communicated via the communication route closest to a predetermined condition. Consequently, it is possible to improve the through-put of the whole communication line network A. Furthermore, it is possible to avoid imbalance of the local line access rate of the communication line network A, thereby improving the communication quality of the communication line network A.

### BACKGROUND OF THE INVENTION AND RELATED ART STATEMENT

The present invention relates to a method and an apparatus (router) for sending/receiving data via a communication route selected and indicated between communication line networks with their network addresses recognized for the connection between those communication line networks, especially between local area networks (LAN). The present invention also relates to a recording medium for storing a program used to select the communication route.

There is an apparatus for sending/receiving data via a communication route set between communication line networks, especially between LANs recognized and specified by their network addresses. (Hereinafter, such an apparatus will be referred to as a router.) This router is configured for routing packets of data between communication line networks according to the information of the third layer “network layer” of the OSI reference model, which is referred to as a network address regulated by ISO.

A network address belongs to an address system managed hierarchically by a network manager. A network address is used to send/receive data via a communication route specified by the manager (static routing) or via a communication route selected automatically by the router itself (dynamic routing).

A conventional router specifies a communication route between communication line networks according to the information of “network layer”, which is the third layer of the OSI reference model and referred to as a network address.

However, this method just specifies one of the communication routes selectable via a communication line network. Consequently, the method has not enabled the most suitable communication route to be selected from a plurality of combinations of selectable communication routes. For example, neither the RIP (Routing Information Protocol) nor the OSPF (Open Shortest Pass First) is configured so as to select a communication route by checking the line efficiency, etc. of the whole communication line network. Both RIP and OSPF are routing protocols used in domains.

Consequently, the conventional method has not controlled so as to improve the through-put of the whole communication line network by controlling the data communication routes optimally in a communication line network. Further, the conventional method has not controlled so as to improve the communication quality of the communication line network by avoiding the imbalance of the local line access rate of the communication quality of the communication line network.

Under such circumstances, it is an object of the present invention to solve the above conventional problems and improve the through-put of the whole subject communication line network by controlling the data communication routes optimally in a communication line network. It is also an object of the present invention to improve the communication quality of the communication line network by avoiding the imbalance of the local line access rate of the communication line network.

### SUMMARY OF THE INVENTION

In order to achieve the above objects, the communication line network selecting method of the present invention for selecting and indicating a connection route between communication line networks so as to send/receive data includes the steps of:

connecting each of a plurality of routers adjacent to each other in a communication line network at a predetermined time;

collecting such line information items as route information, line access rate, line account, line quality, etc.;

combining a plurality of communication routes according to the collected line information;

selecting a communication route closest to a preset condition; then

sending data via the selected communication route.

The communication line network router of the present invention for selecting and indicating a connection route on a communication line network so as to send/receive data includes a processor that executes the following processings for:

connecting each of a plurality of routers adjacent to each other on a communication line network at a predetermined time;

collecting such line information items as route information, line access rate, line account, line quality, etc.;

combining a plurality of communication routes according to the collected line information;

executing an optimization processing for selecting a communication route closest to a preset condition; then

sending data via the selected communication route.

The above processor may be configured so as to collect the number of devices via which data is to be sent/received as a line information item from each of a plurality of the routers, then execute the optimization processing.

The router of the present invention may also include an external apparatus provided outside itself. And, the external apparatus may be provided with a processor for collecting line information items collected by each router at a predetermined time; combining a plurality of communication routes according to the collected line information; executing an optimization processing for selecting a communication route closest to a preset condition; then sending the result of the optimization processing to the subject router.

The recording medium of the present invention stores a program for selecting and indicating a connection route of a router on a communication line network so as to send/receive data. The program enables a computer of the router to execute the processings for:

connecting each of a plurality of routers adjacent to each other on a communication line network at a predetermined time so as to collect such line information items as route information, line access rate, line account, line quality, etc.;

combining a plurality of communication routes according to the collected line information;

selecting a communication route closest to a preset condition; then

sending data via the selected communication route.

According to the above configuration, the router is connected to each of a plurality of routers adjacent to each other at a predetermined time so as to collect line information of the subject communication line network therefrom and execute an optimization processing for selecting an optimal communication route. This optimization processing thus enables a communication route closest to a predetermined condition to be selected and data communications to be done via the selected communication route. Consequently, the optimal data communication route on the subject communication line network at that time can be selected each time the condition of the communication route is changed, at predetermined time intervals, or at a combination of those two items. It is thus possible to improve the through-put of the whole communication line network. And, it is also possible to avoid the imbalance of the local line access rate of the communication line network, thereby improving the communication quality of the communication line network.

In addition to be configured so that each router on the subject communication line collects line information and executes an optimization processing for selecting an optimal communication route, this router may also be configured so that an external apparatus is provided outside itself and the external apparatus collects the line information collected by each router and execute an optimization processing for selecting an optimal communication route, then indicates the selected communication route to the subject router.

### BRIEF DESCRIPTION OF THE DRAWINGS

FIG. 1 is a block diagram of a communication line network in the first embodiment of the present invention.

FIG. 2 is a block diagram of an internal configuration of a router.

FIG. 3 is a flowchart for describing how an optimization processing is done by the router for selecting an optimal communication route.

FIG. 4 is a block diagram of the communication line network when an external apparatus executes an optimization processing in the second embodiment of the present invention.

FIG. 5 is a flowchart for describing how the external apparatus executes an optimization processing for selecting an optimal communication route in the second embodiment of the present invention.

### DETAILED DESCRIPTION OF THE PREFERRED EMBODIMENTS

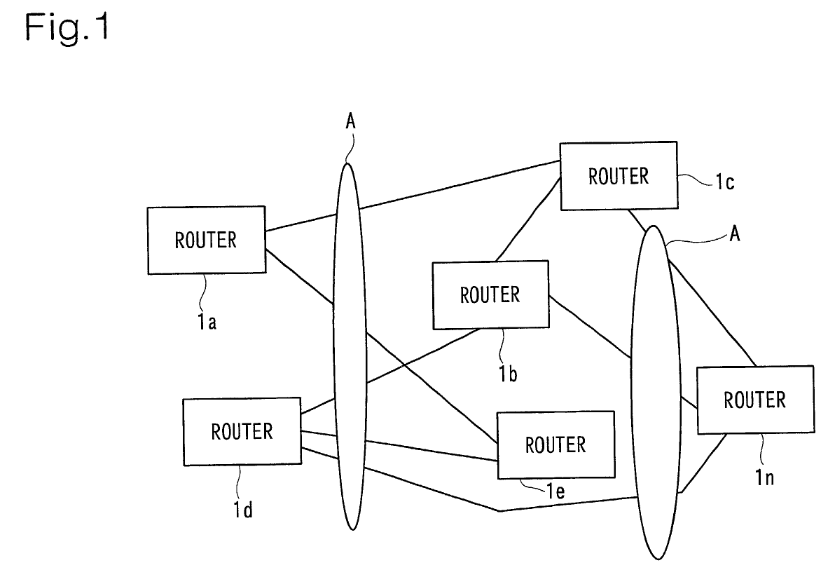

(First Embodiment) Hereunder, the first embodiment of the present invention will be described with reference to the accompanying drawings. The first embodiment is a router provided on a communication line network. FIG. 1 is a block diagram of the communication line network. A plurality of routers 1 (1a, 1b, . . . , 1n) are connected to each other or via a communication line network A respectively.

The router 1(1a) controls a communication route so as to send data to other routers 1b, . . . , 1n via the communication line network A. Especially, because a LAN formed at each router 1 is connected to another LAN formed at another router 1, each of those routers recognizes network addresses and indicates a communication route of the communication line network A so as to send/receive data. This communication route selection is done by specifying routers 1b, . . . , 1n with reference to a routing table used to set communication routes to the network address of each of the routers 1b, . . . , 1n.

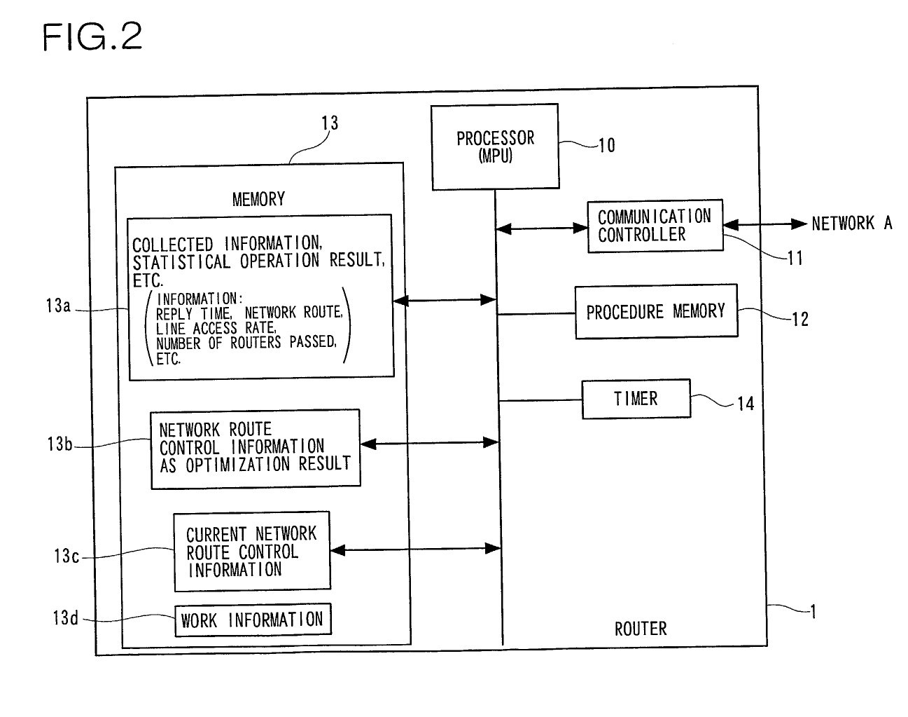

FIG. 2 is a block diagram of an internal configuration of the router 1. Hereunder, the internal configuration and operation of a router 1a will be described.

The router 1 is configured by such a processor 10 as an MPU, etc.; a communication controller 11; a procedure memory 12; such a memory 13 configured by a RAM, etc.; and a timer 14.

The communication controller 11 controls both connection to and communication with the communication line network A. The procedure memory 12 is configured by a ROM, etc. and used to store procedures used by the router 1. The timer 14 counts a time and stores a time set for collecting line information.

The memory 13 is divided into a plurality of memory areas 13a to 13d . The memory area 13a stores line information, as well as the result of a statistical operation, etc. The memory area 13b stores communication line network route control information obtained as a result of an optimization processing. The memory area 13c stores current communication line network route control information. The memory area 13d is a working area used by other processors 10 such as the MPU, etc. The current communication line network route control information stored in the memory area 13c is equivalent to the above-described routing table.

The communication controller 11 of the router 1ais connected to all the adjacent routers 1 (1b, . . . , 1n) so as to collect line information therefrom. The line information collected from each of those routers 1 includes information of the third layer “network layer” of the OSI reference model referred to as router network addresses, information of the communication line network A, route information of the communication line in each router 1, communication line network access rate, line quality, the number of routers via which data is to be sent/received, etc.

According to the procedures stored in the predetermined procedure memory 12 such way, the router 1 collects the line information via the communication controller 11 according to a command from the processor 10. Then, the router 1 stores various types of line information and result information of a statistical processing, etc. in the memory area 13a of the memory 13.

The line account (communication account generated when the subject line is used), which is one of line information items, is set in the router 1aas needed or stored in the memory area 13a of the memory 13 as result information of a statistical processing, etc. together with the line information collected via the communication line network, etc.

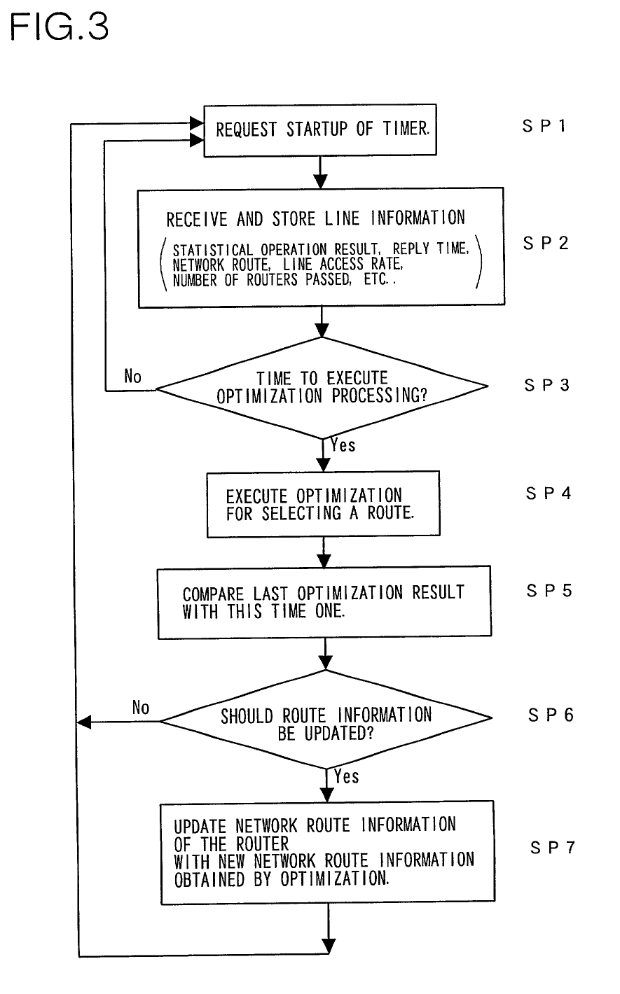

FIG. 3 is a flowchart for describing processing procedures used by the processor 10.

When a predetermined time specified by the timer 14 for collecting line information is reached (SP1), the processor 10 collects line information (reply time, line network route information, line access rate, etc. described above) on the communication line network A via the communication controller 11 and stores the collected information in the memory area 13a (SP2).

When a predetermined time for executing an optimization processing set in the timer 14 is reached (SP3-YES), the router 1 executes an optimization processing for selecting an optimal communication route with use of the collected line information according to the procedures stored in the procedure memory 12 (SP4). The processing in SP3 is executed at a predetermined time after the time of collecting the line information in SP1 is over. The processing in SP3 may also be executed immediately after the processing in SP1 is executed.

The optimization processing makes it possible to obtain an optimal communication route (a combination of communication routes of the routers 1b to 1n), which can send data within the shortest time, for example, from the router 1a to the router 1c. The data sending within such the shortest time is done by calculating the shortest time according to the priority given to each of the line information items (route information, line access rate, line account, line quality, etc.) obtained as an operation parameter.

For example, in case a high priority is set for the line access rate information, a plurality of combinations of communication routes whose line access rate is low respectively are obtained through an arithmetic operation so as to obtain the communication line whose line access rate is the lowest. In case the next priority is set for the line account, a plurality of combinations of communication routes whose line charge is low respectively are obtained through an arithmetic operation so as to obtain the communication route whose line charge is the lowest. Finally, a combination of communication routes with the highest priority is selected from the obtained combinations as a result of the optimization processing.

Especially, in case the priority of the optimization processing is set high with use of the number of routers (line information added to data; the number of routers 1b, . . . , 1n via which data is sent/received) as an operation parameter, it is possible to select a combination of communication routes that requires the least number of routers 1 via which data is to be sent/received.

The RPI, which is a routing protocol used in domains, is limited in the number of routes to be passed (for example, in case packets are discarded when the number of routes is 16 or more), so no data is sent when the number of the routes to be passed is 16 or more. In order to avoid such a trouble (discarding of packets), therefore, the present invention, when the number of routes to be passed is 16 or more in the line information, can switch the communication route to another. In this case, it is only required to set the priority of another operation parameter higher, thereby selecting an optimal communication route through an optimization processing. As a result, data is actually sent after the communication route is selected through the optimization processing, thereby no packet is discarded.

The processor 10 stores the result of the optimization processing in the memory area 13b as communication line network route information. In case the result of this optimization processing is larger than a predetermined range of a communication line network communication route change (set value), the communication route of the communication line network A is calculated again by the optimization method according to the procedure stored in the procedure memory 12. The result is then stored in the memory area 13b.

After this, the processor 10 compares the current communication line network route control information stored in the memory area 13c with the newly calculated communication line network route control information stored in the memory area 13b according to the procedure stored in the procedure memory 12 with reference to the various line control conditions stored in the memory area 13a (SP5).

The processor 10 then selects one of the communication routes, which is an optimal one so as to decide whether or not the current communication route should be updated (SP6). In case the decision is YES, that is, the newly calculated communication line network route control information 13b is selected as a result of the optimization processing, the current communication line network route control information stored in the memory area 13c is updated to the newly calculated one (SP7).

Hereinafter, the router 1a selects and indicates the communication route of the communication line network A according to the updated communication line network route control information stored in the memory area 13c and send/receive data via the updated route of the communication line network A.

While only the router 1a is picked up for the above description for convenience's sake, the communication route in each of the routers 1b to 1n can also be controlled optimally by providing the router 1 (1a to 1n) on the communication line network A with the same function.

(Second Embodiment)

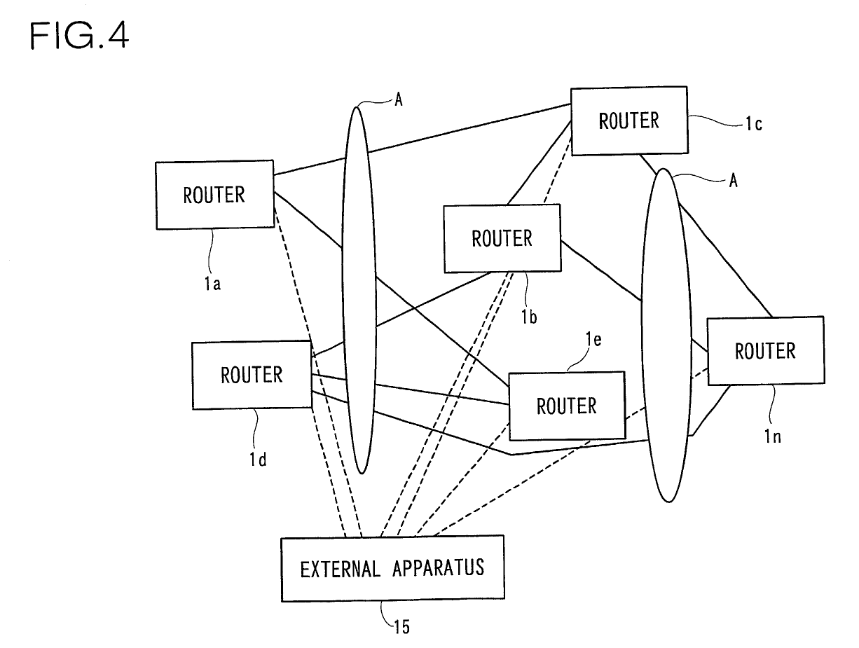

While each router 1 (1a to 1n) executes the optimization processing for selecting an optimal communication route in the above first embodiment, the present invention is not limited only to the embodiment; the external apparatus 15 provided outside the router 1 may execute the optimization processing and the router 1 receives the processing result and indicates the optimal communication route as shown by the block diagram of FIG. 4.

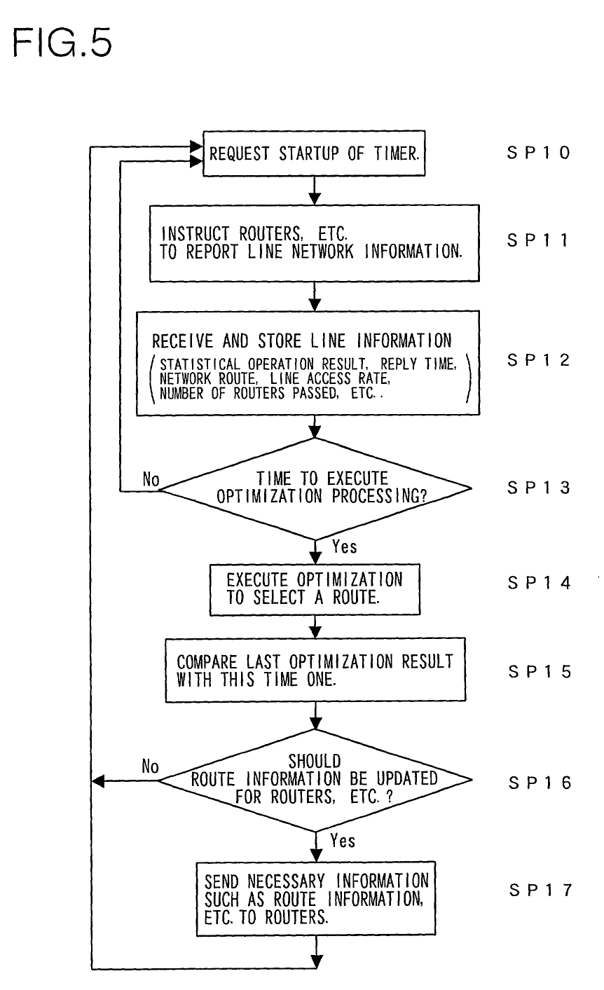

FIG. 5 is a flowchart for describing the procedures used by the external apparatus 15. As shown in the flowchart, the contents of the optimization processing of the external apparatus 15 are almost the same as those shown in FIG. 3. Differences from the flowchart shown in FIG. 3 are addition of a step (SP12) in which receiving a network line information report from the router 1 (SP12) is specified and modification of the contents in the processing (SP16) for deciding whether to update the communication route to the router 1 and in the processing (SP17) for sending necessary information including the communication route to the router 1, etc.

While line information is collected at a predetermined time set in the timer 14 (SP1) in the above embodiment, the time may be varied, for example, when a collection command is entered; when the routing table is updated; when the network configuration is modified, etc. The line is used each time the line information is collected and the line access is accounted at each of those times.

According to each of the embodiments described above, it is possible to execute an optimization processing each time the condition of the communication route, for example, the network configuration is updated, or at time intervals set in the timer 14, or at a combination of those timings so as to optimize the current data communication route in the subject network.

Consequently, it is possible to improve the through-put of the whole communication line network and avoid the imbalance of the local line access rate of the communication line network, thereby improving the communication quality of the communication line network.

Next, another configuration of the present invention 0o will be described. In case each router 1 on the communication route A is provided with a function for collecting the above-described line information, it is possible to collect line information from all the routers via which data is to be sent/received therebetween simultaneously. Consequently, the collection of the line information is never accounted.

Each router, when sending/receiving data, adds a reply time to data to be sent out therefrom as line information. The reply time is a time required to send/receive data between routers. Consequently, the router 1a can obtain a reply time between routers on the subject communication route when sending/receiving data. This reply time can be used as a line information parameter for the above-described optimization processing.

Next, still another embodiment will be described. In case a router collects line information when receiving data, the data receiving order can be used as a parameter for the optimization processing. Assume now that when data is sent from a router to the router 1a, this data is divided into packets A, B, and C and it is sent sequentially in that order. In case the router 1a receives the data in order of the packets B, A, and C, the delay of the packet A hints that the line on the communication route used for sending this packet A is busy. This is why such the packet receiving order (each packet communication route) can be used as a line information parameter for the optimization processing.

According to the present invention, therefore, because data can be sent via a selected optimal communication route on subject communication line network, it is possible to improve the through-put of the whole communication line network and the line quality.

Furthermore, it is also possible to avoid imbalance of the local line access rate of the communication line network, thereby improving the communication quality of the communication line network.

The present invention can therefore obtain the same effect not only in a configuration that each router on a communication line is connected to another so as to collect line information and execute the optimization processing, but also in a configuration that an external apparatus is provided outside each router so as to collect the line information collected by each of other routers so as to execute the optimization processing, then indicate a communication route to the subject router.

What is claimed is:

1. A communication line network connection route selecting method for selecting and indicating a connection route on a communication line network so as to send/receive data, including:
a step of connecting a plurality of adjacent routers provided on said communication line network at a predetermined time;
a step of collecting such line information as route information, line access rate, line account, line quality, etc.;
a step of combining a plurality of said communication routes according to said collected line information;
a step of selecting a communication route closest to a predetermined condition; and
a step of sending data via said selected communication route.

2. A router provided on a communication line network and enabled to send/receive data by selecting and indicating a communication route on said communication line network, including:
a processor to be connected at a predetermined time to a plurality of adjacent routers provided on said communication line network so as to collect such line information as route information, line access rate, line account, line quality, etc., combine a plurality of communication routes according to said collected line information, execute an optimization processing for selecting a communication route closest to a predetermined condition, and send data via said selected communication route.

3. The communication line network router according to claim 2;
wherein said processor collects the number of routers via which data is to be sent/received therefrom/thereto as said line information so as to execute said optimization processing.

4. The communication line network router according to any of claims 2 and 3;
wherein said router includes an external apparatus provided outside itself; and
said external apparatus collects line information from each of a plurality of said routers at a predetermined time, combines a plurality of communication routes according to said collected line information, executes an optimization processing for selecting a communication route closest to a predetermined condition, and sends data via said selected communication route.

5. A recording medium for storing a program for selecting a connection route for a communication line network router so as to send/receive data via a communication route specified on said communication line network, said program enabling a computer of said router to execute the following processings for:
connecting each of a plurality of adjacent routers provided on said communication line network so as to collect such line information as route information, line access rate, line account, line quality, etc. therefrom;
combining a plurality of communication routes according to said collected line information;
selecting a communication route closest to a predetermined condition; and
sending data via said selected communication route.
